(19) United States
(12) Patent Application Publication
(10) Pub. No.: US 2014/0265599 A1
(43) Pub. Date: Sep. 18, 2014

(54) Power Flow Analysis Method and Apparatus for Hybrid AC-DC Systems

(71) Applicant: ABB Technology AG, (US)

(72) Inventors: Xiaoming Feng, Cary, NC (US); Juhua Liu, Cary, NC (US); Ernst Scholtz, Houston, TX (US)

(21) Appl. No.: 13/826,762

(22) Filed: Mar. 14, 2013

(51) Int. Cl. H02J 4/00

(52) U.S. Cl. CPC H02J 4/00
USPC 307/75

(57) ABSTRACT

Power flow in a hybrid AC-DC power system is analyzed by determining DC power injection variables as a function of AC state information for common coupling buses which connect AC and DC grids. The AC state information includes voltage magnitude and phase angle information for the common coupling buses and buses in the AC grid(s). The DC power injection variables indicate AC power injection into the one or more AC grids at the common coupling buses from the DC grid(s). The AC state information is revised iteratively as a function of the DC power injection variables and the sensitivity of the DC power injection variables to the AC state information, and the DC power injection variables and the sensitivity of the DC power injection variables are revised iteratively as a function of the revised AC state information until the power mismatch is acceptable.

### TECHNICAL FIELD

The instant application relates to power flow analysis, and more particularly to power flow analysis for hybrid AC-DC systems with points of common coupling.

### BACKGROUND

Power flow analysis is a core part of power system analysis. For example, a power flow study typically plays a key role in the planning of additions or expansions to transmission and generation facilities. A power flow solution is often the starting point for many other types of power system analyses. In addition, power flow analysis forms the foundation of contingency analysis and the implementation of real-time monitoring systems.

Conventional power flow analysis methodologies typically involve determining element values for passive network components, determining locations and values of all complex power loads, determining generation specifications and constraints, and developing a mathematical model describing power flow in the network. The power flow analysis procedure then solves for the voltage profile of the network, solves for the power flows and losses in the network, and checks for constraint violations.

Power flow analysis becomes even more complex for hybrid AC and high voltage direct current (HVDC) systems, e.g. where the DC system is meshed, and with detailed converter and loss model and control mode modeling. There are primarily three main power flow approaches for hybrid AC-DC systems: the simultaneous approach, the sequential approach, and the load equivalent approach.

The simultaneous approach solves power flow equations for the AC network and the DC network together using a Newton-Raphson method. The simultaneous approach is a straight-forward mathematical formulation with high computational efficiency and good convergence characteristics. The simultaneous approach, however, requires considerable and frequent modification to existing AC power flow programs, and the DC grid model (which can be proprietary) is exposed as part of this approach. Furthermore, extensive modifications to existing AC power flow programs are typically required to accommodate consideration of various DC grid technologies.

The sequential approach solves power flow equations for the AC network and the DC network separately, and requires iteration between AC and DC power flows. The sequential approach is flexible in handling AC and DC power flow separately, which allows for integration of the DC power flow program with any existing AC power flow program without extensive modification. However, the runtime performance of the sequential approach is slow. Convergence is also slow and unreliable. Under some conditions, such as multiple DC islands and distributed slack converter operation, the sequential approach can become non-convergent.

The load equivalent method treats the converters as voltage-dependent loads and eliminates DC variables from the power flow equations, however, the Jacobian matrix of the AC power flow equations must be modified to account for the converters treated as voltage-dependent loads. The load equivalent approach achieves roughly the same runtime performance and convergence characteristics as the simultaneous method, but requires detailed derivation of DC variables as explicit functions of boundary conditions, which is not possible without over-simplification and thus lacks flexibility. Moreover, only classical HVDC has been considered for the load equivalent approach. When the number of DC terminals exceeds three, it becomes impractical to derive these functions using the load equivalent approach which limits the practical application of this technique.

### SUMMARY

According to embodiments described herein, AC and DC power flows are decomposed and the sensitivity of DC grid power injections to the boundary AC states are determined using the chain rule of implicit functions. This approach avoids extensive detailed derivation of the DC grid power injections as an explicit function of the boundary AC states. The sensitivity of the DC grid power injections to the boundary AC states is used to update corresponding AC Jacobian elements. The AC and DC power flows are handled separately and appear as ‘black boxes’ to each other. For example, the only information exchanged between the AC and DC power flows can be the boundary conditions and the Jacobian elements corresponding to common coupling buses, i.e. the buses which connect the AC and DC grids. Repetitive full AC power flow calculations are avoided, and only a single iteration of the AC power flow is performed to obtain new AC boundary states, which are then used by the DC power flow. The corresponding AC Jacobian elements are then updated with the sensitivity of the DC grid power injections to the AC states, ensuring good convergence.

According to an embodiment of exact decomposition method of power flow analysis for a hybrid AC-DC power system having one or more AC grids and one or more DC grids connected by common coupling buses, the method comprises: determining AC state information, including voltage magnitude and phase angle information for the common coupling buses and buses in the one or more AC grids; determining DC power injection variables as a function of the AC state information for the common coupling buses, the DC power injection variables indicating AC power injection into the one or more AC grids at the common coupling buses from the one or more DC grids; determining the sensitivity of the DC power injection variables to the AC state information; and iteratively revising (a) the AC state information as a function of the DC power injection variables and the sensitivity of the DC power injection variables to the current AC state information, and (b) the DC power injection variables and the sensitivity of the DC power injection variables as a function of the revised AC state information, until a power mismatch between the DC power injection variables and corresponding AC power injection variables for the common coupling buses is below a predetermined threshold.

According to an embodiment of a hybrid AC-DC power system, the power system comprises one or more AC grids, one or more DC grids, and common coupling buses connecting the one or more AC grids to the one or more DC grids. The power system further comprises a power flow unit configured to determine AC state information, including voltage magnitude and phase angle information for the common coupling buses and buses in the one or more AC grids, determine DC power injection variables as a function of the AC state information for the common coupling buses, the DC power injection variables indicating AC power injection into the one or more AC grids at the common coupling buses from the one or more DC grids, and determine the sensitivity of the DC power injection variables to the AC state information. The power flow unit is also configured to iteratively revise (a) the AC state information as a function of the DC power injection variables and the sensitivity of the DC power injection variables to the AC state information, and (b) the DC power injection variables and the sensitivity of the DC power injection variables as a function of the revised AC state information, until a power mismatch between the DC power injection variables and corresponding AC power injection variables for the common coupling buses is below a predetermined threshold.

According to an embodiment of a power flow unit for determining a power flow solution for a hybrid AC-DC power system having one or more AC grids and one or more DC grids connected by common coupling buses, the power flow unit comprises a processing circuit configured to determine AC state information, including voltage magnitude and phase angle information for the common coupling buses and buses in the one or more AC grids, determine DC power injection variables as a function of the AC state information for the common coupling buses, the DC power injection variables indicating AC power injection into the one or more AC grids at the common coupling buses from the one or more DC grids, and determine the sensitivity of the DC power injection variables to the AC state information. The processing circuit is also configured to iteratively revise (a) the AC state information as a function of the DC power injection variables and the sensitivity of the DC power injection variables to the current AC state information, and (b) the DC power injection variables and the sensitivity of the DC power injection variables as a function of the revised AC state information, until a power mismatch between the DC power injection variables and corresponding AC power injection variables for the common coupling buses is below a predetermined threshold. The power flow unit further comprises memory configured to store the AC state information, the DC power injection variables, the sensitivity of the DC power injection variables to the AC state information, and the AC power injection variables.

According to an alternate method of power flow analysis for a hybrid AC-DC power system having one or more AC grids and one or more DC grids each with two or more terminals connected by common coupling buses, the method comprises: determining initial DC power injection variables for the common coupling buses based on initial AC state information including voltage magnitude and phase angle information for the common coupling buses and buses in the one or more AC grids, the initial DC power injection variables indicating AC power injection into the one or more AC grids at the common coupling buses from the one or more DC grids; revising the AC state information based on the initial DC power injection variables; determining a sensitivity of the AC state information for the common coupling buses to the initial DC power injection variables; and iteratively revising (a) the DC power injection variables as a function of the revised AC state information and the sensitivity of the AC state information, and (b) the AC state information and the sensitivity of the AC state information as a function of the revised DC power injection variables, until a mismatch of the DC power injection variables between two successive iterations is below a predetermined threshold.

Those skilled in the art will recognize additional features and advantages upon reading the following detailed description and upon viewing the accompanying drawings.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts. In the drawings:

FIG. 1 illustrates a schematic diagram of a hybrid AC-DC system with a power flow unit for performing power flow analysis;

FIG. 2 illustrates a schematic diagram of an AC grid connected to a DC grid by a common coupling bus, and corresponding power flows;

FIG. 3 illustrates a flow diagram of an embodiment of an AC power flow routine for a hybrid AC-DC system;

FIG. 4 illustrates a flow diagram of an embodiment of a DC power flow routine called by the AC power flow routine;

FIG. 5 illustrates a schematic diagram of an exemplary connection between the AC grid and DC grid, where only one PCC bus on the AC grid side and only one converter in a symmetric monopole DC grid are shown;

FIG. 6 illustrates a schematic diagram of another exemplary connection between the AC grid and DC grid, where one PCC bus on the AC grid side and two converters in a bipole DC grid are shown; and

FIG. 7 illustrates a flow diagram of another embodiment of an AC power flow routine for a hybrid AC-DC system.

### DETAILED DESCRIPTION

FIG. 1 illustrates a non-limiting exemplary embodiment of a hybrid AC-DC power system which includes AC grids 100 and DC grids 102, which are connected at point of common coupling (PCC) buses 104 connecting the AC grids to the DC grids. PCC buses are included in both the AC grids 100 and the DC grids 102, but only a single generic PCC bus 104 is shown in FIG. 1 at each point of common coupling for ease of illustration. The hybrid power system further includes a power flow unit 106 for performing the power flow analysis processes described herein. The power flow analysis processes implemented by the power flow unit 106 involve decomposing the AC and DC power flows and determining the sensitivity of DC grid power injections to boundary AC states using the chain rule of implicit functions.

The power flow unit 106 can be located in a single server. Alternatively, components of the power flow unit 106 can be interspersed across more than one server or virtual server in the cloud. The power flow unit 106 can have a wired and/or wireless connection, as indicated by the dashed line connections shown in FIG. 1, or included in one of the grids 100, 102. The power flow unit 106 includes a processing circuit 108, which can include digital and/or analog circuitry, such as one or more processors, ASICs (application-specific integrated circuits), etc. for executing program code which implements the power flow analysis processes described herein. The power flow unit 106 also includes memory 110, such as DRAM (dynamic random access memory), and an HDD (hard disk drive) for storing the program code and related data processed and accessed by the processing circuit 108 during execution of program code. The power flow unit 106 also has I/O (input/output) circuitry 112 for sending and receiving information, including communicating system measurement and parameter information.

In operation, the power flow unit 106 determines AC state information for the PCC buses 104 and buses in the one or more AC grids 100, including voltage magnitude (V) and phase angle (δ) information for these buses. The power flow unit 106 also determines DC power injection variables for the PCC buses 104 as a function of the AC state information. The DC power injection variables denote the AC power injection into the AC grids 100 at the PCC buses 104 from the DC grids 102. The power flow unit 106 also determines the sensitivity of the DC power injection variables to the AC state information.

The DC power injection variables and the sensitivity of the DC power injection variables to the AC state information are used to iteratively revise the AC state information, and the revised AC state information is in turn used to iteratively revise the DC power injection variables and the sensitivity of the DC power injection variables. To this end, the power flow unit 106 executes a DC power flow routine to determine the DC power injection variables and the sensitivity of the DC power injection variables to the AC state information, and calls the DC power flow routine as part of an AC power flow routine executed by the power flow unit 106 for determining the AC state information, the AC power injection variables, and the power mismatch at the PCC buses 104. The AC and DC power flows are handled separately and appear as ‘black boxes’ to each other. In one embodiment, the only information exchanged between the AC and DC power flows is the boundary conditions and the Jacobian elements corresponding to PCC buses 104 i.e. the buses which connect the AC and DC grids 100, 102. As such, the power flow analysis method described herein does not eliminate DC variables, but solves for the DC variables by a separate DC power flow program (i.e. the program that solves the power flow problem for DC grids for specified PCC states). Also, the Jacobian updates are obtained by calculating the sensitivity of DC grid power injections to the boundary AC states using exact evaluation of the Jacobian of the implicit functions. The power flow unit 106 continues the iterative process until the AC-DC power mismatch at the PCC buses 104 is below a predetermined threshold. At this point, the power flow solution has converged, or at least achieved an acceptable level of convergence.

The power flow analysis method is described next in more detail in the context of an interconnected AC-DC system. The interconnected system is partitioned at the PCC buses 104. In the AC grid system model, the DC grids are represented by equivalent power injections. In the DC grid system model, the effect of the AC grids is represented by corresponding voltage magnitudes and phase angles at the PCC buses 104. The DC grids 102 include converter transformers, phase reactors, converters, DC conductor (e.g. overhead lines or cables, or underground cables) networks, and grounding, which are not shown in FIG. 1 for ease of illustration. Such components are shown in later figures (FIGS. 5 and 6).

The power flow analysis method is described next in more detail, with particular reference to power balance equations for the PCC buses 104. With these power balance equations, no assumptions about the control mode in the DC grids 102 are made. The results, therefore, are generally applicable to various types of DC grids 102 and any multi-terminal systems. Although the following power balance equations below are expressed in terms of real power, it should be readily understood by those skilled in the art that the power flow procedure can also be applied to corresponding reactive power balance equations.

FIG. 2 illustrates the power balance at one of the PCC buses 104. The selection of the reference flow direction (from the DC grid 102 to the AC grid 100) is arbitrary and can be reversed. The power injection P_{pcc}^{AC}(x_{AC}) represents the power injection at the PCC bus 104 calculated from the AC side, and the power injection P_{pcc}^{DC}(x_{AC}) represents the power injection at the PCC bus 104 calculated from the DC side. The notation x_{AC} represents a state vector for the AC grids 100 including the PCC bus 104 (but not the AC nodes in the DC grids 102 except for the PCC buses 104), where x_{AC} includes voltage magnitudes (V) and phase angles (δ) of all AC buses in the AC grids 100 and of the PCC bus 104.

FIG. 3 illustrates an embodiment of the AC power flow routine and FIG. 4 illustrates an embodiment of the DC power flow routine which is executed by the power flow unit 106 to estimate power flow in a hybrid AC-DC system. The power flow method is described in the context of the hybrid AC-DC power system shown in FIG. 1 and the power balance diagram shown in FIG. 2. The power flow method can be executed by the power flow unit 106, particularly by the processing circuit 108, by accessing code and corresponding data stored in the memory/HDD 110. The following equations use subscript ‘pcc’, which stands for point of common coupling or ‘PCC’ for short.

In FIG. 3, the AC state vector x_{AC} is first initialized as part of the AC power flow routine (200). This includes initializing voltage magnitudes (V) and phase angles (δ) of all AC buses in the AC grids 100, including the PCC buses 104. The voltage magnitudes and phase angles of the PCC buses 104 represent boundary conditions for the DC power flow routine which is called later by the power flow unit 106. The AC power flow routine also initializes the power balance equations as given by:

P_{pcc}^{AC}(x_{AC})−P_{pcc}^{AC}(x_{AC})=0 (1)

where P_{pcc}^{AC}(x_{AC}) is the power injection at the PCC buses 104 calculated from the AC side and P_{pcc}^{DC}(x_{AC}) is the power injection at the PCC buses 104 calculated from the DC side as explained above. The power injection calculated from the DC side is dependent on the PCC bus states in addition to other internal states of the DC grids 102. The dependence on the internal states of the DC grids 102 is not shown explicitly in the equations given herein for notation simplicity.

The hybrid AC-DC system can be presumed to have a steady-state equilibrium point. At the equilibrium point, the complex (P, Q) power injection into the PCC buses 104 from the DC side can be calculated by the DC power flow routine. The DC power flow routine is provided the portion of the AC state vector x_{AC} for the PCC buses 104 as boundary conditions (202). If the DC grid 102, excluding the PCC buses 104, is removed and replaced with equivalent complex (P, Q) power injections calculated from the equilibrium state x, then the AC state information obtained from the AC power flow solution will be the same as obtained from a conventional simultaneous power flow solution.

Regardless, the DC power flow routine determines the DC power injection variables P_{pcc}^{DC}(x_{AC}) as a function of the AC state information provided by the AC power flow routine for the PCC buses 104 (204). The DC power injection variables indicate AC power injection into the AC grids at the PCC buses 104 from the DC grids. The DC power flow routine also determines the sensitivity of the DC power injection variables to the AC state information for the PCC buses 104, in the form of a partial Jacobian matrix

$$\frac{\partial {P}_{pcc}^{DC}}{\partial {x}_{AC}}$$

(204).

These DC power flow equations for the specified AC conditions (voltage magnitudes and phase angles) of the PCC buses 104 can be expressed in general form as:

ƒ_{DC}(x_{DC},x_{AC})=0 (2)

where x_{AC} is used for notation simplicity even though the DC grid power flow equations depend explicitly on the sub-vector of x_{AC} which corresponds to the PCC buses 104. The vector x_{DC} represents all internal states of the DC grids 102, which also includes the voltage magnitude and phase angle variables of the AC buses 100 except for the PCC buses 104. The function ƒ_{DC}(x_{DC},x_{AC}) represents the power flow equations for the DC grids 102, and typically includes power flow balance equations for AC buses on the DC grid side, DC grid control law equations, DC conductor network equations, power conversion equations for DC side converters, grounding equations, etc. The exact form of the DC power flow equation is irrelevant for the purpose of power flow analysis method described herein, and therefore no further explanation is given in this regard.

The DC power injection variables P_{pcc}^{DC}(x_{AC}) and the partial Jacobian matrix

$$\frac{\partial {P}_{pcc}^{DC}}{\partial {x}_{AC}}$$

calculated for the DC side are then provided to the AC power flow routine as DC boundary conditions (206). For the initial iteration of the power flow analysis method, it is presumed that the power mismatch is nonzero and greater than a predetermined threshold i.e. non-convergent (208, 210). Otherwise, the AC state vector x_{AC} would be the solution (212).

The following Newton-Raphson iterative equations are then solved as part of the power flow analysis method to modify x_{AC}. First, the AC power flow routine calculates the power mismatch ΔP_{pcc} (214) at the PCC buses 104 based on the AC power injection variables P_{pcc}^{AC}(x_{AC}) calculated at the AC side for the PCC buses 104 and the DC power injection variables P_{pcc}^{DC}(x_{AC}) calculated at the DC side for the PCC buses 104 as given by:

ΔP_{pcc}=P_{pcc}^{DC}(x_{AC})−P_{pcc}^{AC}(x_{AC}) (3)

If ΔP_{pcc} is below a predetermined threshold, sufficient convergence exists and the AC state vector x_{AC} is found (216, 218, 210, 212). If not, the AC power flow routine determines a partial Jacobian matrix

$$\frac{\partial {P}_{pcc}^{AC}}{\partial {x}_{AC}}$$

representing the sensitivity of the AC power injection variables to the current AC state information x_{AC}(220). The AC power flow routine uses the partial Jacobian matrix

$$\frac{\partial {P}_{pcc}^{AC}}{\partial {x}_{AC}}$$

together with the boundary conditions P_{pcc}^{DC}(x_{AC}) and the partial Jacobian matrix

$$\frac{\partial {P}_{pcc}^{DC}}{\partial {x}_{AC}}$$

received from the DC power flow routine to solve the following equation:

$$( \frac{\partial {P}_{pcc}^{DC}}{\partial {x}_{AC}} - \frac{\partial {P}_{pcc}^{AC}}{\partial {x}_{AC}} ) Δ {x}_{AC} = - ( {P}_{pcc}^{DC} ( {x}_{AC} ) - {P}_{pcc}^{AC} ( {x}_{AC} ) ) \qquad ( 4 )$$

The right-hand side of equation (3) can be calculated the same way as in the conventional sequential approach method. In addition, the partial Jacobian matrix

$$\frac{\partial {P}_{pcc}^{AC}}{\partial {x}_{AC}}$$

is determined by the topology and parameters of the AC grids 100, and is evaluated explicitly by the AC grid power flows. The partial Jacobian matrix

$$\frac{\partial {P}_{pcc}^{DC}}{\partial {x}_{AC}}$$

is determined by the topology and parameters and control laws of the DC grids 102, and is not evaluated by explicit functions.

The DC power flow equation (2) for some initial boundary condition (k) has already been solved as given by:

ƒ_{DC}(x_{DC}^{(k)},x_{AC}^{(k)})=0 (5)

For incremental changes in the AC state vector x_{AC}, the new equilibrium for the DC grid side becomes x_{DC}^{(k)}+Δx_{DC}. This relationship can be used by the AC power flow routine to re-calculate (222) and update (224) the AC state vector x_{AC} based on the boundary conditions P_{pcc}^{DC}(x_{AC}) and the partial Jacobian matrix

$$\frac{\partial {P}_{pcc}^{DC}}{\partial {x}_{AC}}$$

from the DC side, and also based on the current AC power injection variables P_{pcc}^{AC} and the current partial Jacobian matrix

$$\frac{\partial {P}_{pcc}^{AC}}{\partial {x}_{AC}}$$

representing the sensitivity of the AC power injection variables to the current AC state information as given by:

$$\begin{matrix}{f}_{DC} ( {x}_{DC}^{( k )} + Δ {x}_{DC} , {x}_{AC}^{( k )} + Δ {x}_{AC} ) = 0 & ( 6 ) \\ {f}_{DC} ( {x}_{DC}^{( k )} , {x}_{AC}^{( k )} ) + \frac{\partial {f}_{DC}}{\partial {x}_{DC}} Δ {x}_{DC} + \frac{\partial {f}_{DC}}{\partial {x}_{AC}} Δ {x}_{AC} = 0 & ( 7 ) \\ \frac{\partial {f}_{DC}}{\partial {x}_{DC}} Δ {x}_{DC} + \frac{\partial {f}_{DC}}{\partial {x}_{AC}} Δ {x}_{AC} = 0 & ( 8 )\end{matrix}$$

With a revised AC state vector x_{AC}, the AC power flow routine can also revise the AC power injection variables P_{pcc}^{AC}(x_{AC}) through the use of known techniques. The AC power flow routine sends the part of the revised AC state vector x_{AC} pertaining to the PCC buses 104 to the DC power flow routine as modified boundary conditions (226).

The DC power flow routine receives the pertinent part of the revised AC state vector x_{AC} (228, 300). The DC power flow routine solves the DC grid power flow equation (5) as a function of the revised AC state vector x_{AC} (228, 302). The DC power flow routine also re-calculates the sensitivities of the DC power flow solution as a function of the revised AC state (boundary) vector x_{AC} for the PCC buses 104 (228, 304) as given by:

$$\frac{\partial {x}_{DC}}{\partial {x}_{AC}} = - {( \frac{\partial {f}_{DC}}{\partial {x}_{DC}} )}^{- 1} \frac{\partial {f}_{DC}}{\partial {x}_{AC}} \qquad ( 9 )$$

If the revised DC power injection variables are included in the DC power flow formulation explicitly, i.e., P_{pcc}^{DC} is included in the state vector x_{DC} for the DC grid power flow, the partial Jacobian matrix representing the sensitivity of the DC power injection variables with respect to the AC boundary conditions can be calculated directly from equation (9) (228, 306). In this case, the partial Jacobian matrix is based on partial derivatives of the DC power flow state vector ƒ_{DC} with respect to the DC state information x_{DC} and partial derivatives of the DC power flow state vector ƒ_{DC} with respect to the AC state information x_{AC} for the PCC buses 104.

If the revised DC power injection variables are not included in the DC power flow formulation explicitly, P_{pcc}^{DC} is a function of the DC side states, and the Jacobian matrix can be calculated by the DC power flow routine (228, 306) as given by:

$$\frac{\partial {P}_{pcc}^{DC}}{\partial {x}_{AC}} = \frac{\partial {P}_{pcc}^{DC}}{\partial {x}_{DC}} \frac{\partial {x}_{DC}}{\partial {x}_{AC}} \qquad ( 10 )$$

In this case, the partial Jacobian matrix is based on partial derivatives of the DC power injection variables P_{pcc}^{DC} with respect to the AC state information x_{AC} for the PCC buses 104, partial derivatives of the DC power injection variables P_{pcc}^{DC} with respect to the DC state information x_{DC} for the DC grids 102, and partial derivatives of x_{DC} with respect to x_{AC}.

Both equation (9) and equation (10) yield the partial Jacobian matrix in equation (4). In either case the revised DC power injection variables P_{pcc}^{DC}(x_{AC}) and the revised sensitivity in the form of partial Jacobian matrix

$$\frac{\partial {P}_{pcc}^{DC}}{\partial {x}_{AC}}$$

are provided to the AC power flow routine (230, 308, 310). The AC power flow routine uses P_{pcc}^{DC}(x_{AC}) and

$$\frac{\partial {P}_{pcc}^{DC}}{\partial {x}_{AC}}$$

as boundary conditions as previously described herein to again revise the AC power injection variables P_{pcc}^{AC}(x_{AC}) and the AC state vector x_{AC}. The iterative power flow analysis process continues until the power mismatch at all AC grid buses are below a user specified threshold.

FIG. 5 illustrates an exemplary connection between the AC grid 100 and DC grid 102, where only one PCC bus 104 on the AC grid side and only one converter in a monopole DC grid 102 are shown. In this example, the state variables for the PCC bus 104, the DC bus, and a few representative AC buses are shown for illustration purpose. These state variables, in conjunction with other state variables not shown, are used by the power flow analysis method described herein. Complex power (P₁, Q₁) is delivered to the AC grid 100 from a transformer 400. The transformer 400 is connected to a phase reactor 402. An optional filter 404 can be provided between the transformer 400 and the phase reactor 402. The DC grid 102 also includes a converter 406, DC conductor networks 408, and high-frequency grounding 410. The configuration in this case is symmetric monopole.

Nodes 1, 2 and 3 represent AC buses, and nodes 4 and 5 represent DC buses. In such a configuration, the AC state information x_{AC} includes voltage magnitude (V) and phase angle (δ) information for each PCC bus 104 (represented by node 1) and other AC buses in the AC grids 100 that are not shown. Although nodes 1, 2 and 3 are AC nodes, they are part of the DC grid 102 and therefore their corresponding state information (V, δ) is included in the DC state information x_{DC}. The DC state information x_{DC} further includes voltage (U) and current (I) information for each DC bus (represented by nodes 4 and 5). The AC and DC state information x_{AC} and x_{DC} are used to calculate AC and DC power injection at the PCC bus 104 and corresponding sensitivities, and are iteratively revised to achieve a power flow solution as previously described.

FIG. 6 illustrates another exemplary connection between the AC grid 100 and the DC grid 102, where one PCC bus 104 on the AC grid side and two converters (a positive pole converter and a negative pole converter) in a bipole DC grid 102 are shown. Complex power (P₁, Q₁) is delivered to the AC grid 100 from the DC grid 102 at the PCC bus 104. In the bipole configuration, complex power (P₁ₚ, Q₁ₚ) from the positive pole (hence the subscript ‘p’) is delivered to the PCC bus 104 by a corresponding transformer 400. Similarly, complex power (P₁ₙ, Q₁ₙ) from the negative pole (hence the subscript ‘n’) is delivered to the PCC bus 104 by a corresponding transformer 400. Each transformer 400 is connected to a corresponding phase reactor 402. An optional filter 404 can be connected between each transformer 400 and phase reactor 402. The DC grid 102 further includes converters 406, DC conductor networks 408 and regular grounding 412.

In the bipole configuration, nodes 1 through 5 represent AC buses and nodes 6 through 8 represent DC buses. In such a configuration, the AC grid state information x_{AC} includes voltage magnitude (V) and phase angle (δ) information for the PCC bus 104 (represented by node 1) and other buses in the AC grids 100 that are not shown. Although nodes 1 through 5 are AC nodes, they are part of the DC grid 102 and therefore their corresponding state information (V, δ) is included in the DC state information x_{DC}. The DC grid state information x_{DC} further includes voltage (U) and current (I) information for three DC buses (represented by nodes 6 through 8). The AC and DC state information x_{AC} and x_{DC} are used to calculate AC and DC power injection at the PCC bus 104 and corresponding sensitivities, and are iteratively revised to achieve an power flow solution as previously described. The methodology described herein is also applicable to other DC grid configurations.

FIG. 7 illustrates another embodiment of the AC power flow routine which is executed by the power flow unit 106 to estimate power flow in a hybrid AC-DC system. The power flow method is described in the context of the hybrid AC-DC power system shown in FIG. 1 and the power balance diagram shown in FIG. 2. The power flow method can be executed by the power flow unit 106, particularly by the processing circuit 108, by accessing code and corresponding data stored in the memory/HDD 110. The following equations use subscript ‘pcc’, which stands for point of common coupling or ‘PCC’ for short. According to the embodiment shown in FIG. 7, the DC power flow information is not used to update the Jacobian matrix for the AC grid power flow.

The power flow embodiment illustrated in FIG. 7 is explained in the context of the following equations, where the focus is on the power balance at one PCC bus regardless of the PCC bus types and the control mode of the corresponding converter station. Although the equations below are written in terms of real power, those skilled in the art readily understand that the same procedure can be applied to reactive power balance equations. With this understanding, it can be assumed that an initial estimate of the power injection P_{pcc}^{DC(0)} from the converter station is available. Generating this initial estimate is a trivial task if the converter is in constant P, Q control mode, or by solving for the DC grid power flow with flat boundary condition. In either case, solving the AC power flow yields an initial AC state vector x_{AC}⁽⁰⁾ which is a superset of the initial boundary bus state.

With the boundary bus condition x_{AC}⁽⁰⁾ fixed, the DC power flow is solved based on the AC state vector x_{AC}⁽⁰⁾ i.e. the converter power injections P_{pcc}^{DC(0)} by the DC grids 102 into PCC buses 104 are estimated based on the initial AC state vector x_{AC}⁽⁰⁾ as previously described herein (700). The initial DC power injection P_{pcc}^{DC(0)} is sent from the DC power flow routine to the AC power flow routine (702).

The AC power flow routine uses P_{pcc}^{DC(0)} i.e. the initial power injections into the PCC buses 104 from the DC grids 102 calculated based on the AC state vector x_{AC}⁽⁰⁾ to solve the AC power flows, update x_{AC}, and calculate the boundary bus sensitivities

$$\frac{\partial {x}_{AC}}{\partial {P}_{pcc}}$$

with respect to PCC power injections based on the AC equations previously described herein (704, 706). The AC power flow routine sends the revised x_{AC} and ∂x_{AC}/∂P_{pcc} to the DC power flow routine (708).

The DC power flow routine calculates the DC power flow for the fixed x_{AC} and determines new power injections P_{pcc}^{DC(1)} at the PCC buses 104 from the DC grids 102 based on x_{AC} and

$$\frac{\partial {x}_{AC}}{\partial {P}_{pcc}}$$

(710). A solution has peen round if the newly calculated power injections P_{pcc}^{DC(1)} are the same as the initial power injections P_{pcc}^{DC(0)} within an acceptable margin of error ε as given by (712, 714, 716):

|P_{pcc}^{DC(1)}−P_{pcc}^{DC(0)}|≦ε, (11)

If convergence has not yet occurred, the DC power flow routine calculates the sensitivities of P_{pcc} with respect to the revised boundary condition x_{AC} based on the DC equations

$$\frac{\partial {P}_{pcc}^{DC}}{\partial {x}_{AC}}$$

as previously described herein (718). The DC power flow routine also calculates a correction vector ΔP_{pcc}^{DC} which is added to the initial estimate P_{pcc}^{DC(0)} as given by:

P_{pcc}^{DC(0)}+ΔP_{pcc} (12)

Based on the incremental change in power injection, the AC state vector x_{AC} can be updated as given by:

$$\begin{matrix}{x}_{AC}^{( 0 )} + Δ {x}_{AC} \\ and & ( 13 ) \\ Δ {x}_{AC} = \frac{\partial {x}_{AC}}{\partial {P}_{pcc}} Δ {P}_{pcc} & ( 14 )\end{matrix}$$

where Δx_{AC} is the change in the AC state vector corresponding to the incremental change in power injection ΔP_{pcc} and

$$\frac{\partial {x}_{AC}}{\partial {P}_{pcc}}$$

is a partial Jacobian matrix representing the sensitivity of the AC power injection variables to the current power injections P_{pcc} at the PCC buses 104 from the DC grids 102.

The change in the DC power injection to the AC power flow is given by:

$$\begin{matrix}{P}_{pcc}^{DC ( 0 )} + Δ {P}_{pcc} \\ and & ( 15 ) \\ Δ {P}_{pcc} = \frac{\partial {P}_{pcc}}{\partial {x}_{AC}} Δ {x}_{AC} & ( 16 )\end{matrix}$$

This should be equal to the power injection used to calculate the AC power flow, as given by:

$${P}_{pcc}^{DC ( 0 )} + Δ {P}_{pcc} = {P}_{pcc}^{DC ( 1 )} + \frac{\partial {P}_{pcc}}{\partial {x}_{AC}} \frac{\partial {x}_{AC}}{\partial {P}_{pcc}} Δ {P}_{pcc} \qquad ( 17 )$$

where

$$\frac{\partial {P}_{pcc}}{\partial {x}_{AC}}$$

is a partial Jacobian matrix representing the sensitivity of the DC power injection variables to the current AC state information x_{AC}.

Based on the above, the DC power flow routine solves for the power injection correction ΔP_{pcc} based on the following iteration equation (720):

$$( I - \frac{\partial {P}_{pcc}}{\partial {x}_{AC}} \frac{\partial {x}_{AC}}{\partial {P}_{pcc}} ) Δ {P}_{pcc} = {P}_{pcc}^{DC ( 1 )} - {P}_{pcc}^{DC ( 0 )} \qquad ( 18 )$$

The DC power flow routine sends the equivalent injection P_{pcc}, which is the P_{pcc}^{DC(0)} for the next iteration, to AC power flow routine (722, 702). The iterative process continues until equation (11) is satisfied or another stopping criterion is satisfied.

Terms such as “first”, “second”, and the like, are used to describe various elements, regions, sections, etc. and are not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. An exact decomposition method of power flow analysis for a hybrid AC-DC power system having one or more AC grids and one or more DC grids each with two or more terminals connected by common coupling buses, the method comprising:
determining AC state information including voltage magnitude and phase angle information for the common coupling buses and buses in the one or more AC grids;
determining DC power injection variables as a function of the AC state information for the common coupling buses, the DC power injection variables indicating AC power injection into the one or more AC grids at the common coupling buses from the one or more DC grids;
determining the sensitivity of the DC power injection variables to the AC state information; and
iteratively revising (a) the AC state information as a function of the DC power injection variables and the sensitivity of the DC power injection variables to the current AC state information, and (b) the DC power injection variables and the sensitivity of the DC power injection variables as a function of the revised AC state information, until a power mismatch between the DC power injection variables and corresponding AC power injection variables for the common coupling buses is below a predetermined threshold.

2. The method according to claim 1, wherein the sensitivity of the DC power injection variables to the AC state information is represented by a partial Jacobian matrix.

3. The method according to claim 2, wherein the partial Jacobian matrix is based on partial derivatives of a DC power flow state vector with respect to DC state information for the one or more DC grids and partial derivatives of the DC power flow state vector with respect to the AC state information for the common coupling buses, the DC power flow state vector including the DC power injection variables and additional DC state information for the one or more DC grids.

4. The method according to claim 2, wherein the partial Jacobian matrix is based on partial derivatives of the DC power injection variables with respect to the AC state information for the common coupling buses, partial derivatives of the DC power injection variables with respect to DC state information for the one or more DC grids and partial derivatives of the DC state information with respect to the AC state information for the common coupling buses.

5. The method according to claim 2, wherein the AC state information is revised in a current iteration based on the DC power injection variables, the partial Jacobian matrix representing the sensitivity of the DC power injection variables to the current AC state information, the AC power injection variables, and a partial Jacobian matrix representing the sensitivity of the AC power injection variables to the current AC state information.

6. The method according to claim 1, wherein the power mismatch is determined based on the difference between the DC power injection variables and the AC power injection variables for the common coupling buses.

7. The method according to claim 1, wherein the DC power injection variables and the sensitivity of the DC power injection variables to the AC state information are determined by a DC power flow routine which is called as part of an AC power flow routine for determining the AC state information, the AC power injection variables and the power mismatch.

8. A hybrid AC-DC power system, comprising:
one or more AC grids;
one or more DC grids;
common coupling buses connecting the one or more AC grids to the one or more DC grids; and
a power flow unit configured to:
determine AC state information including voltage magnitude and phase angle information for the common coupling buses and buses in the one or more AC grids;
determine DC power injection variables as a function of the AC state information for the common coupling buses, the DC power injection variables indicating AC power injection into the one or more AC grids at the common coupling buses from the one or more DC grids;
determine the sensitivity of the DC power injection variables to the AC state information; and
iteratively revise (a) the AC state information as a function of the DC power injection variables and the sensitivity of the DC power injection variables to the AC state information, and (b) the DC power injection variables and the sensitivity of the DC power injection variables as a function of the revised AC state information, until a power mismatch between the DC power injection variables and corresponding AC power injection variables for the common coupling buses is below a predetermined threshold.

9. The hybrid AC-DC power system according to claim 8, wherein the power flow unit is configured to represent the sensitivity of the DC power injection variables to the AC state information as a partial Jacobian matrix.

10. The hybrid AC-DC power system according to claim 9, wherein the power flow unit is configured to construct the partial Jacobian matrix based on partial derivatives of a DC power flow state vector with respect to DC state information for the one or more DC grids and partial derivatives of the DC power flow state vector with respect to the AC state information for the common coupling buses, the DC power flow state vector including the DC power injection variables and additional DC state information for the one or more DC grids.

11. The hybrid AC-DC power system according to claim 9, wherein the power flow unit is configured to construct the partial Jacobian matrix based on partial derivatives of the DC power injection variables with respect to the AC state information for the common coupling buses, partial derivatives of the DC power injection variables with respect to DC state information for the one or more DC grids and partial derivatives of the DC state information with respect to the AC state information for the common coupling buses.

12. The hybrid AC-DC power system according to claim 9, wherein the power flow unit is configured to revise the AC state information in a current iteration based on the DC power injection variables, the partial Jacobian matrix representing the sensitivity of the DC power injection variables to the current AC state information, the AC power injection variables, and a partial Jacobian matrix representing the sensitivity of the AC power injection variables to the current AC state information.

13. The hybrid AC-DC power system according to claim 8, wherein the power flow unit is configured to determine the power mismatch based on the difference between the DC power injection variables and the AC power injection variables for the common coupling buses.

14. The hybrid AC-DC power system according to claim 8, wherein the power flow unit is configured to execute a DC power flow routine to determine the DC power injection variables and the sensitivity of the DC power injection variables to the AC state information, and call the DC power flow routine as part of an AC power flow routine executed by the power flow unit for determining the AC state information, the AC power injection variables and the power mismatch.

15. A power flow unit for determining a power flow solution for a hybrid AC-DC power system having one or more AC grids and one or more DC grids connected by common coupling buses, the power flow unit comprising:
a processing circuit configured to:
determine AC state information including voltage magnitude and phase angle information for the common coupling buses and buses in the one or more AC grids;
determine DC power injection variables as a function of the AC state information for the common coupling buses, the DC power injection variables indicating AC power injection into the one or more AC grids at the common coupling buses from the one or more DC grids;
determine the sensitivity of the DC power injection variables to the AC state information; and
iteratively revise (a) the AC state information as a function of the DC power injection variables and the sensitivity of the DC power injection variables to the current AC state information, and (b) the DC power injection variables and the sensitivity of the DC power injection variables as a function of the revised AC state information, until a power mismatch between the DC power injection variables and corresponding AC power injection variables for the common coupling buses is below a predetermined threshold; and
memory configured to store the AC state information, the DC power injection variables, the sensitivity of the DC power injection variables to the AC state information, and the AC power injection variables.

16. The power flow unit according to claim 15, wherein the processing circuit is configured to represent the sensitivity of the DC power injection variables to the AC state information as a partial Jacobian matrix.

17. The power flow unit according to claim 16, wherein the processing circuit is configured to construct the partial Jacobian matrix based on partial derivatives of a DC power flow state vector with respect to DC state information for the one or more DC grids and partial derivatives of the DC power flow state vector with respect to the AC state information for the common coupling buses, the DC power flow state vector including the DC power injection variables and additional DC state information for the one or more DC grids.

18. The power flow unit according to claim 16, wherein the processing circuit is configured to construct the partial Jacobian matrix based on partial derivatives of the DC power injection variables with respect to the AC state information for the common coupling buses, partial derivatives of the DC power injection variables with respect to DC state information for the one or more DC grids and partial derivatives of the DC state information with respect to the AC state information for the common coupling buses.

19. The power flow unit according to claim 16, wherein the processing circuit is configured to revise the AC state information in a current iteration based on the DC power injection variables, the partial Jacobian matrix representing the sensitivity of the DC power injection variables to the current AC state information, the AC power injection variables, and a partial Jacobian matrix representing the sensitivity of the AC power injection variables to the current AC state information.

20. The power flow unit according to claim 15, wherein the memory is further configured to store a DC power flow routine for determining the DC power injection variables and the sensitivity of the DC power injection variables to the AC state information and store an AC power flow routine for determining the AC state information, the AC power injection variables and the power mismatch, and wherein the processing circuit is configured to call the DC power flow routine as part of the AC power flow routine.

21. A method of power flow analysis for a hybrid AC-DC power system having one or more AC grids and one or more DC grids each with two or more terminals connected by common coupling buses, the method comprising:
determining initial DC power injection variables for the common coupling buses based on initial AC state information including voltage magnitude and phase angle information for the common coupling buses and buses in the one or more AC grids, the initial DC power injection variables indicating AC power injection into the one or more AC grids at the common coupling buses from the one or more DC grids;
revising the AC state information based on the initial DC power injection variables;
determining a sensitivity of the AC state information for the common coupling buses to the initial DC power injection variables; and
iteratively revising (a) the DC power injection variables as a function of the revised AC state information and the sensitivity of the AC state information, and (b) the AC state information and the sensitivity of the AC state information as a function of the revised DC power injection variables, until a mismatch of the DC power injection variables between two successive iterations is below a predetermined threshold.
